(19) United States
(12) Patent Application Publication
(10) Pub. No.: US 2013/0262205 A1
(43) Pub. Date: Oct. 3, 2013

(54) ONLINE STORE

(71) Applicant: SHOPA LTD, Wooburn Green (GB)

(72) Inventor: Peter Allen Janes, Buckinghamshire (GB)

(73) Assignee: SHOPA LTD, Wooburn Green (GB)

(21) Appl. No.: 13/826,361

(22) Filed: Mar. 14, 2013

Related U.S. Application Data
(60) Provisional application No. 61/616,798, filed on Mar. 28, 2012.

(51) Int. Cl. G06Q 30/02

(52) U.S. Cl. CPC G06Q 30/0214
USPC 705/14.16

(57) ABSTRACT

An online store referral system is provided that includes an online store server comprising records of items for sale, a referral service server, separate from the online store server, and a primary referrer. A shopper computer system, of a shopper, is operative to receive from the primary referrer a link to an item for sale in the online store and to follow that link to make a purchase from the online store of the item for sale. The online store server is operative to inform the referral service server of a purchase of an item for sale following on from the link for that item being followed. The referral service server is operative to credit the primary referrer with a commission in respect of the sale of the item.

### RELATED APPLICATIONS

The present application claims benefit of U.S. Provisional Patent Application No. 61/616,798, filed Mar. 28, 2012, entitled “Online Store,” which is hereby incorporated by reference for all purposes as if set forth herein in its entirety.

### BACKGROUND OF THE INVENTION

Online stores are numerous on the Internet for selling goods, which are then delivered by post or courier, or are even collected by the user from a physical store. A system for a typical online store is shown in FIG. 1. A shopper (not shown per se) uses a client program on their computer 10, or other device—for example a smartphone, to interact with a store application on a server 20. Most often the client will be a general purpose web browser, such as Microsoft Internet Explorer or Google Chrome and the store application will be an application for a web server such as Microsoft Internet Information Server or Apache. However, dedicated client programs are becoming more popular, especially on smartphones.

The shopper can search in the store goods according to keywords and/or various criteria such as price or brand or keywords by submitting 101 those criteria to the server 20, which returns 102 to the shopper's computer 10 a hit list of possibilities from a database 21 of goods handled by the store, i.e. the database comprises records of items for sale. Usually a whole page or set of pages giving detailed information about a particular product is provided 104 to the user in response to the shopper selecting 103 an item from the hit list. Items are usually selected for purchase by a process involving a shopping basket metaphor. The shopper selects an item for purchase by clicking 105 a link for that purpose, either on the hit list or on the item detailed information page and the server responds by adding that item to the set of items the shopper wishes to purchase, known as the shopping basket. This allows the shopper to make selections of various items to be included in the shopping basket before actual order is placed, the latter step usually requiring a payment step. Until the order is placed the shopper can view a list of the items in the shopping basket and make adjustments such as the number of each item to buy or to delete items that are not in fact desired. The next step is for the shopper to indicate 110 that they wish to proceed to purchase the items in the shopping basket, again by clicking a suitable link. The server 20 then gathers from the user information needed to process and accept the order, for example by sending 111 the client a series of forms to display so that the shopper can fill them in 112. These usually include (i) the delivery address and delivery method and (ii) payment details, which is often credit or debit card details.

The payment is commonly collected from shopper's bank or credit card company in real time by the online store server 20 submitting a request 120 for payment not directly to the bank's computers 30 but to the server 40 of a payment gateway service. This service provides simpler interfaces to the online store than would be available by dealing directly with the bank. It may also provide some extra authentication of the shopper's identity, by asking the shopper to provide 121 certain personal details in web forms. The gateway interacts with the bank to arrange for the bank to make the payment from the shopper's bank account to that of the online store, which is summarised in the Figure as a payment request 122 and payment confirmation 123. The payment gateway 40 then confirms 124 to the online store server 20 that payment has been made.

Once the payment is confirmed the online store server 20 passes the details of the goods purchased and proposed delivery to a delivery fulfillment system (not shown), which can vary in complexity from a simple list of goods printed out for a dispatcher to put into envelopes to take to the post office, to a fully automated warehouse.

Basic online shopping applications are available to be purchased ready for use, except of course that the online store operator needs to populate the database of goods with descriptions, photographs and pricing information of the goods for sale.

These online shopping applications deal very well with selection of items while the shopper is actually using the online store, i.e. in the case of a web browser client, while visiting the online store's website. However, they do not deal with the promotion of goods available in the online store outside of the online store.

A known online store has an affiliates program, which is also illustrated in the system of FIG. 1. This allows a person to sign up 130 with the online store as an affiliate (which can be done online from the affiliate's computer 50), which includes providing the address of where the affiliate proposes to host a link to a page in the in the online store for a particular product. The online store's server 20 will then provide 131 such a link 60 to the affiliate, which the affiliate then includes in a page 61 of the affiliate's website. For ease of illustration affiliate's computer 50 is shown as being both the one from which the affiliate signs up for a link and the one hosting the affiliate's website—more usually they would be separate computers. An affiliate's website may, of course, include more than one such link for different products sold by the online store.

A shopper visiting the affiliate's website will, of course, request 132 pages from that site and receive 133 them for display on their computer 10, for example page 61. If the shopper then clicks on link 60 contained in that page, the shopper's browser will then follow 134 the link, i.e. request 103′ from the online store's server the product page identified in the link. The server checks that the link clicked was on the affiliate's website and if so responds with the product page 104′ for the relevant product and further the server notes that the link used was provided by the affiliate. The shopper can then if they wish click 105′ to add the purchase to the basket and then later click 110′ to buy the product as before. When the linked product is purchased the online store server 20 credits the affiliate with a commission (in an account belonging to the affiliate held by the online store).

This has the advantage that the goods receive a wider promotion than that provided by the online store. The benefit to the affiliate, apart perhaps from being seen as helpful by those using the link, is of course the commission. However, as will be seen in the light of the invention, this system does have limitations.

### SUMMARY OF THE INVENTION

In a first aspect of the invention there is provided an online store referral system comprising:

a. an online store server comprising records of items for sale,

b. a referral service server, separate from the online store server,

c. a primary referrer, and

d. a shopper computer system, of a shopper, operative to receive from the primary referrer a link to an item for sale in the online store and to follow that link to make a purchase from the online store of the item for sale,

e. wherein the online store server is operative to inform the referral service server of a purchase of an item for sale following on from the link for that item being followed, and

f. wherein the referral service server is operative to credit the primary referrer with a commission in respect of the sale of the item.

The referral service server may be also operative to credit the shopper with a commission in respect of the sale of the item.

The online store may be operated by a first organisation and the referral service server may be operated by a second organisation that is independent of the first organisation.

The referral service server may be at a different site from the online store server.

The online store referral system may comprise a plurality of online stores, each having an online store server comprising a respective set of records of items for sale,

a. wherein each online store server of the plurality is operative to inform the referral service server of a purchase of an item for sale following on from the link for that item being followed, and

b. wherein the referral service server is operative to credit the primary referrer with a commission in respect of each sale of an item so purchased.

The primary referrer may have a computer system and wherein the primary referrer computer system and the referral service server may be operative to interact to provide the link to the item for sale.

The referral service server may be operative to generate the link to the item for sale and to communicate the link to the primary referrer computer system. The referral system server may be operative to record the link to the item for sale.

The referral service server may be operative record the link to the item for sale and the link to the em for sale may comprise an identifier from which the referral service system can identify the link.

The referral service server may comprise a link generation web page and the online store may comprise product web pages each comprising a link to the link generation web page.

The online store server may be operative to provide product pages for particular ones of the items it has for sale and the link to an item for sale may be a direct link to a product page from the online store server for a particular product.

The online store server may be operative to provide product pages for particular ones of items it has for sale, wherein the link to an item for sale is a link to the referral service server, and wherein the referral service server is responsive to the link being followed to cause a redirect to a product page from the online store server for a particular product.

The online store server may be operative perform the informing of the purchase of an item by sending a message directly to the referral system server over a communications network.

The online store server, the referral service server, and the shopper computer system may be connected by a communications network.

The first aspect of the invention also provides a referral service server, wherein the referral service server is

a. operative to receive, from an online store server separate from the referral service server, information of a purchase of an item for sale by the online store server following on from a link for that item being followed by a shopper that received the link directly or indirectly from a primary referrer, and

b. operative to credit the primary referrer with a commission in respect of the sale of the item.

The referral service may also be operative to credit the shopper with a commission in respect of the sale of the item.

The referral service server may be operated by a second organisation that is independent of a first organisation that operates the online store.

The referral service server may be at a different site from the online store server.

The referral service server may be operative to credit the primary referrer with a commission in respect of each sale of an item purchased following on from the link for that item being followed, at a plurality of online stores.

The referral service server maybe operative to interact with a computer system of the primary referrer to provide the link to the item for sale.

The referral service server may be operative to generate the link to the item for sale and to communicate the link to the primary referrer computer system.

The referral system server may be operative record the link to the item for sale.

The referral service server may be operative to record the link to the item for sale and the link to the item for sale may comprise an identifier from which the referral service system can identify the link.

The referral service server may comprise a link generation web page.

The referral service server may be operative to generate the link to an item for sale in the online store in form that is a direct link to a product page from the online store server for a particular product.

The referral service server may be operative to generate the link to an item for sale in the online store in form that is a link to the referral service server, and the referral service server may be responsive to the link being followed to cause a redirect to a product page from the online store server for a particular product.

The first aspect of the invention further provides a method of selling an item online comprising:

a. generating a link to a product for sale in an online store associated with a primary referrer,

b. distributing the link to the product to a shopper,

c. the shopper following the link and purchasing the product from the online store,

d. the online store informing a referral service, separate from the online store, of the purchase, and

e. the referral service crediting the primary referrer with a commission for the sale of the item.

The method may further comprise the referral service crediting the shopper with a commission for the sale of the item.

The online store may be operated by a first organisation and the referral service may be operated by a second organisation that is independent of the first organisation.

The referral service may be at a different site from the online store.

A plurality of online stores may inform the referral service of purchases following a shopper following the link, and the referral service may credit the primary referrer with a commission for those sales of items.

The link may comprise an identifier from which the referral service can identify the link.

The link may be a direct link to a product page from the online store for a particular product.

The link may be to a server of the referral service, the method including the referral service server being responsive to the link being followed to cause a redirect to a product page from the online store for a particular product.

According to a second aspect of the invention there provided an online store referral system comprising:

a. an online store server comprising records of items for sale,

b. a referral service server,

c. a primary referrer, and a secondary referrer able to receive from the primary referrer a link to an item for sale in the online store,

d. a shopper computer system, of a shopper, operative to receive from the secondary referrer the link to an item for sale in the online store and to follow that link to make a purchase from the online store of the item for sale,

e. wherein the online store server is operative to inform the referral service server of the purchase of an item for sale following on from the link for that item being followed by a shopper that received the link from the secondary referrer, and

f. wherein the referral service server is operative to credit the primary referrer with a commission in respect of the sale of the item.

The referral service server may also be operative to credit the shopper with a commission in respect of the sale of the item.

The primary referrer may have a computer system and the primary referrer computer system and the referral service server may be operative to interact to provide the link to the item for sale.

The referral service server may be operative to generate the link to the item for sale and to communicate the link of the primary referrer computer system.

The referral system server may be operative record the link to the item for sale.

The referral service server may be operative record the link to the item for sale and the link to the item for sale may comprise an identifier from which the referral service system can identify the link.

The referral service server may comprise a link generation web page and the online store may comprise product web pages each comprising a link to the link generation web page.

The online store server may be operative to provide product pages for particular ones of the items it has for sale and the link to an item for sale may be a direct link to a product page from the online store server for a particular product.

The online store server may be operative to provide product pages for particular ones of items it has for sale, wherein the link to an item for sale is a link to the referral service server, and wherein the referral service server is responsive to the link being followed to cause a redirect to a product page from the online store server for a particular product.

The second aspect of the invention also provides a referral service server, wherein the referral service server is

a. operative to receive from an online store server information of a purchase of an item for sale by the online store server following on from a link for that item being followed by a shopper that received the link from a primary referrer via a secondary referrer, and

b. operative to credit the primary referrer with a commission in respect of the sale of the item.

The referral service server may also be operative to credit the shopper with a commission in respect of the sale of the item.

The referral service server may be operative to interact with a computer system of the primary referrer to provide the link to the item for sale.

The referral service server may be operative to generate the link to the item for sale and to communicate the link to the primary referrer computer system.

The referral system server may be operative to record the link to the item for sale.

The referral service server may be operative to record the link to the item for sale and the link to the item for sale may comprise an identifier from which the referral service system can identify the link.

The referral service server may comprise a link generation web page.

The referral service server may be operative to generate the link to an item for sale in the online store in form that is a direct link to a product page from the online store server for a particular product.

The referral service server may be opera generate the link to an item for a in the online store in form that is a link to the ref service server, and the referral service server maybe responsive to the link being followed to cause a redirect to a product page from the online store server for a particular product.

The second aspect of the invention further provides a method of selling an item online comprising:

generating a link to a product for sale in an online store associated with a primary referrer,

a. distributing the link to the product to a shopper, from the primary referrer via at least one secondary referrer,

b. the shopper following the link and purchasing the product from the online store,

c. the online store informing a referral service of the purchase, and

d. the referral service crediting the primary referrer with a commission for the sale of the item.

The method may further comprise the referral service crediting the shopper with a commission for the sale of the item.

The link may comprise an identifier from which the referral service can identify the link.

The link may be a direct link to a product page from the online store for a particular product.

The link may be a server of the referral service, the method including the referral service server being responsive to the link being followed to cause a redirect to a product page from the online store for a particular product.

In a third aspect of the invention there is provided a voucher referral system comprising:

a. a store having a point-of-sale terminal,

b. a primary referrer, and a shopper,

c. a referral service server operative to generate a voucher associated with the primary referrer and a link to that voucher,

d. a computer system operative to receive from the primary referrer the link to the voucher and to print the voucher,

e. wherein the point-of-sale terminal is operative to scan the printed voucher and to inform the referral service server of use of the voucher, and

f. wherein the referral service server is operative to credit the primary referrer with a commission in respect of that use.

The store may be operated by a first organisation and the referral service server may be operated by a second organisation that is independent of the first organisation.

The store may be a physical store.

The referral service server may be at a different site from the store.

The voucher referral system may comprise a plurality of stores, each having a point-of sale terminal,

a. wherein each point-of-sale terminal is operative to scan a said printed voucher and inform the referral service server use of that voucher, and

b. wherein the referral service server is operative to credit the primary referrer with a commission in respect that use.

The primary referrer may have a computer system and the primary referrer computer system and the referral service server may be operative to interact to provide the link to the voucher.

The referral service server may be operative to communicate the link to the voucher to the primary referrer computer system.

The voucher referral server may be operative to provide an image of the voucher to a computer requesting it using the link to the voucher.

The voucher may comprise scannable information.

The voucher may comprise a barcode.

The scannable information may include information relating to a benefit to the shopper.

The point-of-sale terminal may be operative provide a benefit to the shopper.

The point-of-sale terminal may be operative perform the informing of the use of the voucher by sending a message directly to the referral system server over a communications network.

The point-of-sale terminal, the referral service server, and the computer system may be connected by a communications network.

The third aspect of the invention also provides referral service server, wherein the referral service server is

a. operative to generate a voucher associated with a primary referrer and a link to that voucher,

b. operative to receive, from a point-of-sale terminal information of use of the voucher by a shopper that received the voucher directly or indirectly from a primary referrer, and

c. operative to credit the primary referrer with a commission in respect the use of the voucher.

The referral service server may be operated by a second organisation that is independent of a first organisation that operates the store.

The referral service server may be at a different site from the store.

The referral service server may opera credit the primary referrer with a commission in respect of each said use of the voucher at a plurality of stores.

The referral service server may be operative interact with a computer system of the primary referrer to provide the link to the voucher.

The referral service server may be operative to generate the link to the voucher and to communicate the link to the primary referrer computer system.

The referral system server may be operative to record the link to the voucher.

The referral service server may be operative to provide an image of the voucher to a computer requesting it using the link to the voucher.

The voucher may comprise scannable information.

The voucher may comprise a barcode.

The scannable information may include information relating to a benefit to the shopper.

The point-of-sale terminal may be operative to provide a benefit to the shopper.

The referral service server may comprise a voucher link generation web page.

The third aspect of the invention further provides a method of using a voucher comprising:

a. generating a link to a voucher associated with a primary referrer,

b. distributing the link to the voucher,

c. a shopper using the voucher at a point-of-sale terminal of a store,

d. the point-of-sale terminal informing a referral service server of the use of the voucher, and

e. the referral service server crediting the primary referrer with a commission for the use of the voucher.

The store may be operated by a first organisation and the referral service server may be operated by a second organisation that is independent the first organisation.

The referral service server may be at a different site from the online store.

A plurality of stores may have a point of sale terminal that informs the referral service server a shopper using the voucher, and the referral service server may credit the primary referrer with a commission for each of those uses.

The method may comprise the voucher referral server providing an image of the voucher to a computer requesting it using the link to the voucher.

The method may comprise providing on the voucher scannable information.

The method may comprise providing on the voucher a barcode.

The scannable information may include information relating to a benefit to the shopper.

The method may comprise the point-of-sale terminal providing a benefit to the shopper.

The method may comprising the point-of-sale terminal informing of the use of the voucher by sending a message directly to the referral system server over a communications network.

### BRIEF DESCRIPTION OF THE FIGURES

Examples of the invention will now be described with reference to the accompanying Figures of which:

FIG. 1 shows an example of a known basic online store system with an affiliate advertising system,

FIG. 2 shows an example of an advertising system for an online store according to the present invention,

FIG. 3A is a first screen of a product link generation pop-up,

FIG. 3B is a subsequent screen of a product link generation pop-up,

FIG. 4A is an overview diagram of the steps taken by the system of FIG. 2,

FIGS. 4B to 4E are more detailed diagrams of the steps taken by the system of FIG. 2,

FIG. 5 shows an example of a voucher system according to the present invention,

FIG. 6 shows an example of a voucher.

### EXAMPLES

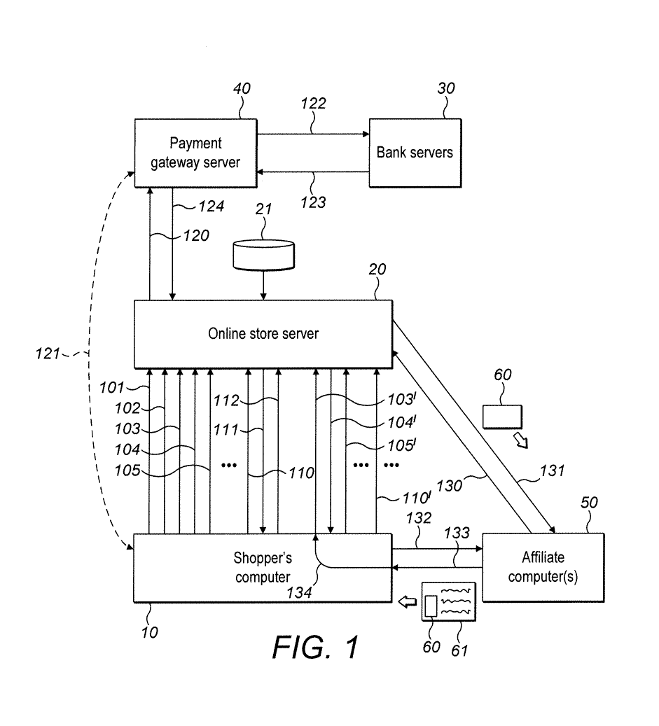

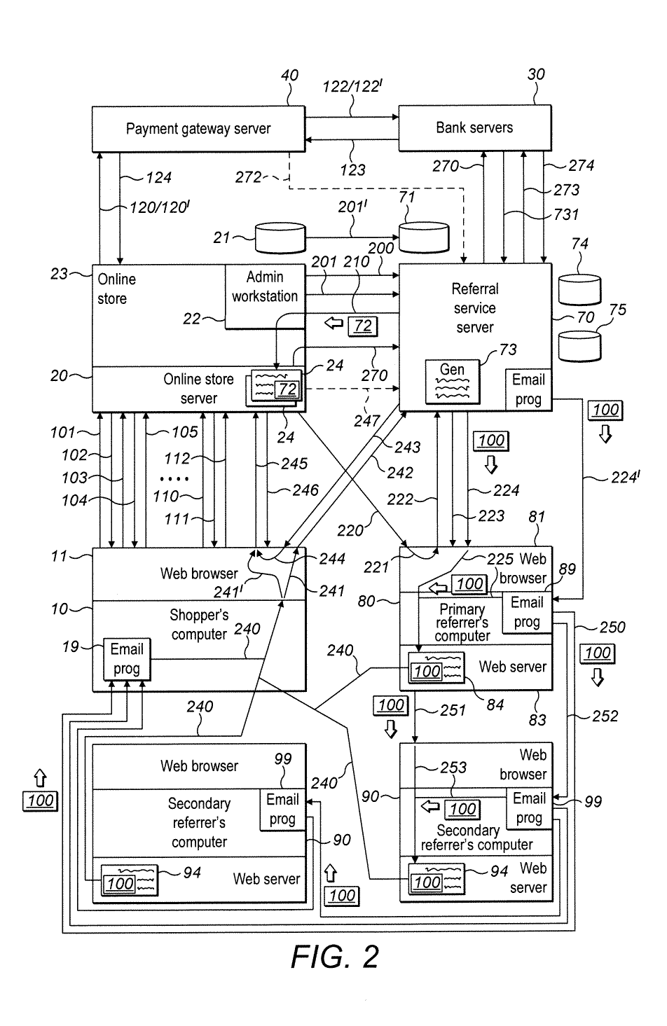

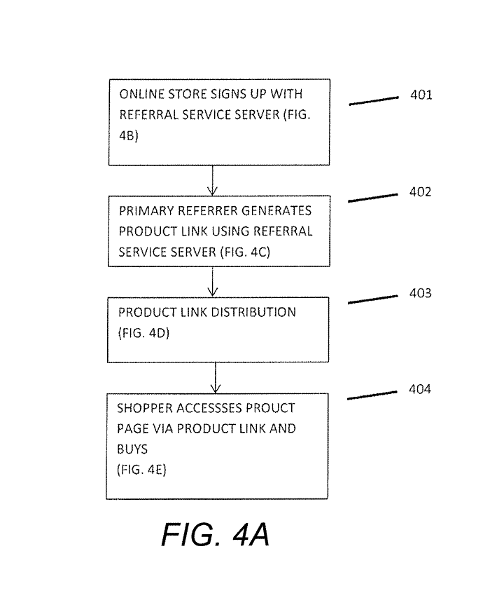

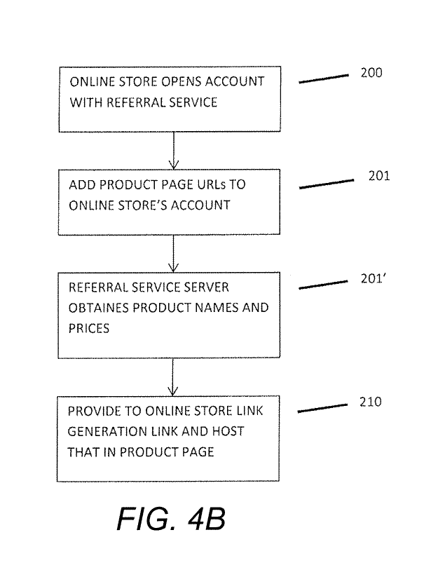

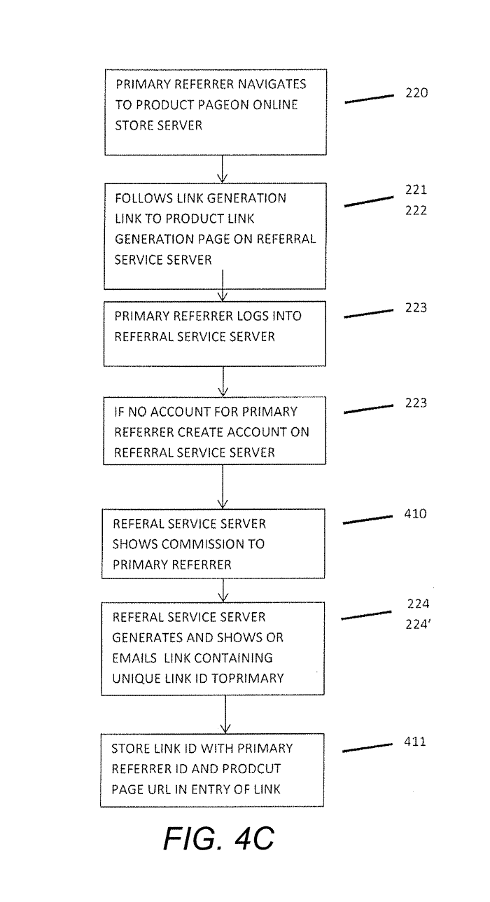

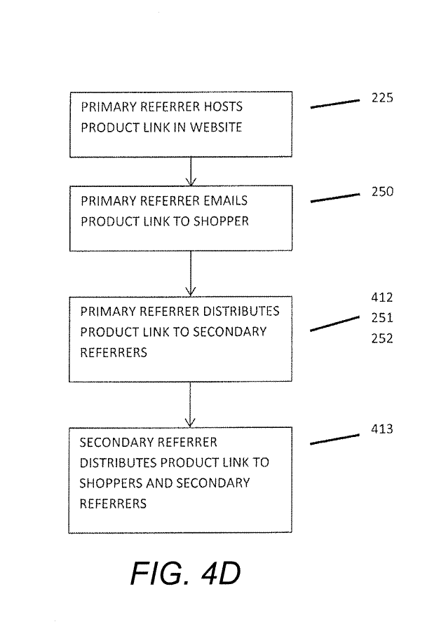

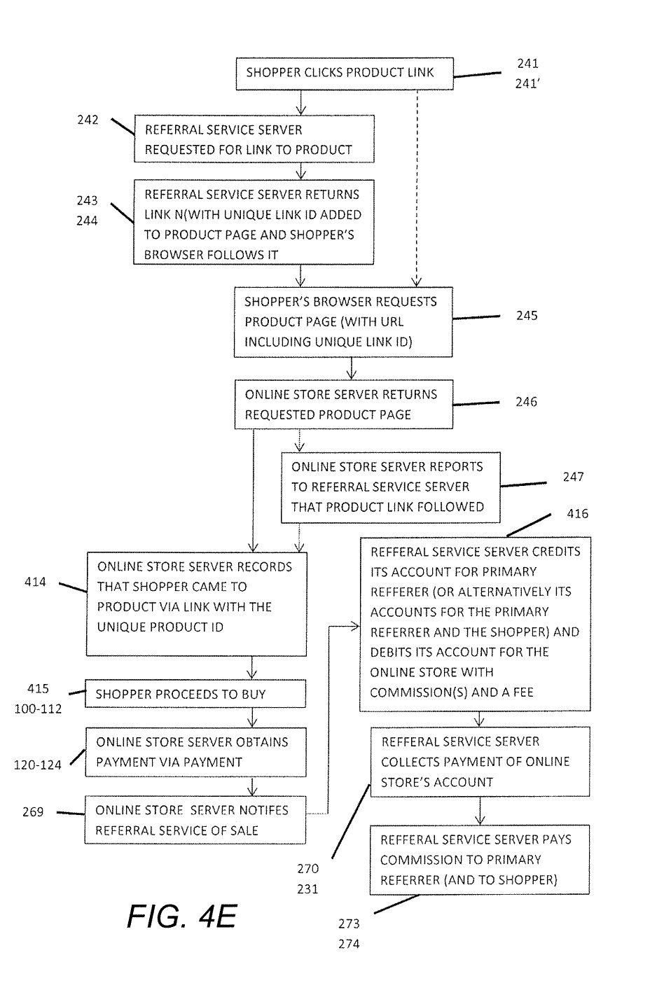

FIG. 2 illustrates an example of the invention. This provides an improvement to an online store system, for example, one similar to that described in FIG. 1. The computers that are similar to those FIG. 1, and also arrows for similar interactions, are marked with the same reference numerals. (Note that a key to the arrows in FIGS. 1 and 2 has been provided at the end of this description). The steps taken by the system are illustrated also in FIGS. 4A to 4E; in those Figures the steps are marked with the same reference numerals as the arrows in FIG. 2 where they correspond.

As before, an online store server 20 of an online store 23 interacts with a client 11 on a shopper's computer (in this example a web browser) and as before the shopper may search for items and add them to their basket 101-105 and then buy them 110-112. However the system is provided with a referral service server computer 70. As will be described in detail this provides to the online store services for the distribution of links to products in the store and administration of referrer's commissions.

All the computers of the system can be located anywhere and are connected by a communications network, for example, the Internet. In this example the messages described are passed between the computers using the network (unless some other form of communication is described). The computers of course send the messages and take the actions described herein under the control of software for the purpose. Collectively therefore the computers perform an algorithm, as will be seen, for creating a link to a product in an online store for a primary referrer to distribute, distributing that link to shoppers, and crediting the primary referrer with a commission when the link is used to buy a product.

An online store 23 wishing to make use of the referral service begins (also FIGS. 4B and 401 in FIG. 4A) by opening an account 200 for that on the referral service provider via web pages for the purpose served by the referral service server computer 70, accessed for example by an operator from a workstation computer 22 at the online store 23. (Note that while only one online store is shown the referral system server computer 70 can serve more than one online store, or indeed many). Following that the online store's operator uses the administration pages served by the referral service server computer 70 to indicate 201 which products of the online store should be included in the referral service by providing the URL for the relevant product pages. For single product pages this can be done by typing in the URL of the product page but for multiple product pages a file containing a list of the URLs for each product page can be uploaded. These are saved by the referral service server 70 in its product database 71, each with a product page ID unique to that database (the same product from a different online store will be on a different product page by definition and so has a different product page ID).

Further information can also be provided, for example, the name and cost of the products. So each record in the database 71 contains the fields:

1. Unique Product ID
i. 2. URL of product page
ii. 3. Product name
iii. 4. Product price

The further information is obtained for example in the information uploaded by the online store operator or by the referral service server 70 obtaining (using the URLs) the product pages from the online store server 20 and screen scraping the information. This duplication of information from the online store's product database 21 to the product database 71 of the referral service is summarised in FIG. 2 by arrow 201′.

The online store also provides to the referral service server 70, in this set up stage, commission rates to be paid to primary referrers. This may be on a per product basis (e.g. recorded as an additional field of the records in the product database 71) or for sets of products and may be in the form of percentage or an absolute amount. During this process the referral service server advises the online store that further sums will be payable to it in addition to those to be paid in commissions to primary referrers. The online store also provides at this stage details that will allow the referral service to collect those sums, in the preferred payment arrangement described below.

It is notable that the referral service server 70 is a separate server from the online store server. This means that the online store does not have to implement the referral service functions for itself. Indeed conveniently the referral service server 70 can be set up at a different site and may be operated by a different organisation independent from that operating the online store.

The referral service provides 210 to the online store a link generation link 72 to be used on the product pages 24 of the online store server. In this example the product link generation link has a simple form, the same for all product pages 24 of the online store server 20, and is a link to a primary referrer link generation page 73 on the referral service server 70.

A primary referrer in this system is a person wishing to promote products in an online store and receive commission in return. (See also FIGS. 4C and 402 in FIG. 4A) A primary referrer 80 wishing to promote a product provided by the online store 23 first navigates 220 with their web browser 81 to the product page 24 the online store and then clicks the product link generation link 72 on that page. (Alternatively, of course, the referrer may decide that they would like to promote the product while viewing the product page 24, but the action is the same: the primary referrer clicks the product link generation link 72 on the product page 24).

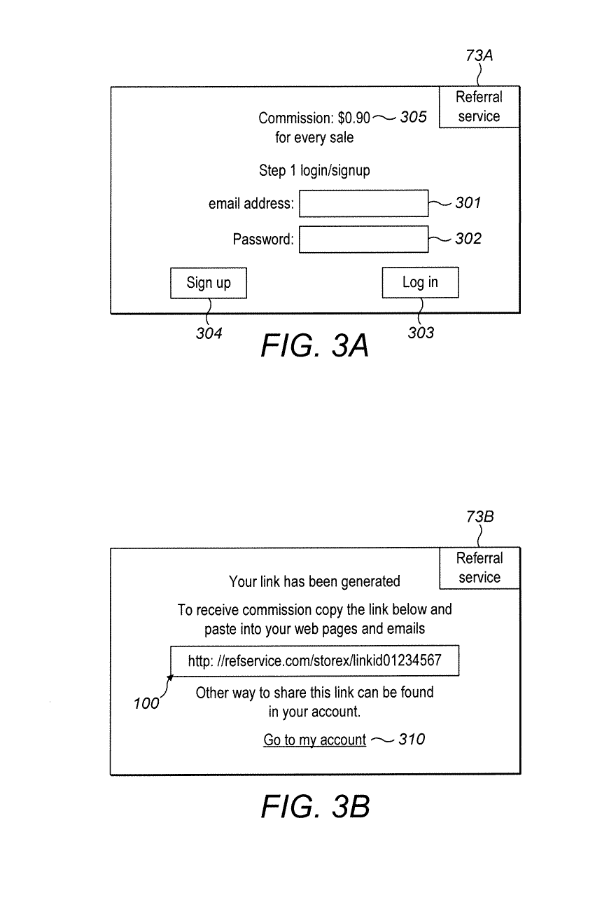

In response to the clicking of that link 72 the web browser 81 of the primary referrer follows 221 the link and requests 222 the product link generation page from the referral service server 70. This is shown to the primary referrer as a pop-up window. The referral service server 70 first checks that the primary referrer 80 is logged in with that server. If not it logs them in automatically (if the primary referrer is recognised), or prompts them to do so manually, as shown in FIG. 3A where the pop-up window is shown at 73A by entering username 301 (e.g. email address) and a password 302 and clicking a login button 303, or invites them to create an account with the referral service by clicking a sign up button 304 if they do not have an account. The account is created in the primary referrer accounts database 75 of the referral service. (All these stages are summarised as arrow 223 in FIG. 2).

The pop-up page 73A also shows 410 the primary referrer the amount of commission 305 that they will be paid for every sale of the product. This is shown early by way of encouragement to the primary referrer. The amount of commission is calculated by the referral service server 70 in the products database 71 from the information on commission rates provided by the online store when submitting the product to the referral service. The information is located from the URL of the product page that is passed to the referral service server by the primary referrer's web browser 81 when the link generation link 72 on the product page 24 is clicked. (If the log in is automatic the primary referrer is still shown the commission amount but the login and sign up buttons are replaced by a button for the primary referrer to click to progress to the next stage, which is to see the product link that they will use.)

Once the primary referrer is logged in, etc., the referral service server 70 then utilises the URL of the product page 24 on which the product link generation link 72 was clicked to generate and display 224 to the primary referrer on a page 73B (also in the pop-up window), FIG. 3B, that contains a link 100 to the product page 24, which link is specific to that particular primary referrer and that product page. The link can, alternatively, be sent by other means to the primary referrer, for example email 224′.

The product page link 100 can be of various forms. The preferred form is a hypertext link, and so begins “http:”, with the next part “//refservice.com” identifying the referral service server 73. (As is conventional a machine name e.g. “www”, may be added the basic domain name. (The actual domain name used here is of course exemplary). After that follow two parameters; these are shown separated by “/” characters but again other syntaxes are possible, for example, that using a “?” and then named parameters with the names and values of those joined by an “=”. The first parameter is the name of the online store of which the product page forms a part; the exemplary value being here “STOREX”—this is preferably provided only for the information and reassurance of shoppers who might click the link. The next parameter is a link ID, i.e. an identifier, in the referral service server's link database 74 that is specific to that combination of product page and primary referrer; here the exemplary value of the link ID is “01234567” prepended with a constant “LINKID” which again is provided only for the reassurance of shoppers who might click the link.

Another possible form is the basic URL of the product page 24 (i.e. the URL in the online store itself) with the unique link ID parameter concatenated to it.

The link ID is stored 411 in a new entry of the referral service server's link database 74 together with the ID of the primary referrer's account with the referral service (and preferably—see below—the URL the product page).

So in the link database 74 each entry preferably comprises the following fields:˜

1. Link ID
i. 2. Primary referrer's account
ii. 3. URL of product page

(Preferably the link ID is a long random number so that a valid one cannot be guessed at by some unauthorised person wishing to generate links.)

The primary referrer may host the product link 100 in a page 84 on a website (e.g. their own website) where a shopper may follow it to view the web page for the product in the online shop and hopefully buy the product. (See also FIGS. 4D and 403 in FIG. 4A). Arrow 225 signifies the primary referrer copying the link 100 from the web page or email that the referral service server 70 sent it with to the web page 84.

However, the primary referrer may also distribute the link to shoppers in other ways. This can be done by various methods. A first example of this is that the primary referrer can cause the product link to be displayed to potential shoppers on any website on which he may alter the content, for example, a social media or networking website, so that the user can follow the link from there to online store. A second method is to email 250 the product link to a shopper, e.g. between an email program 89 on one of the primary referrer's computers to an email program 19 on the shopper's computer 10.

Similarly the primary referrer may distribute the product link 100 to secondary referrers 90. Again this may be done by displaying the product link 100 on a website on a server where he may alter the content, for example, again his own 84 or one on which he controls the content, for the secondary referrer to view 251. Further, again, the primary referrer 80 may email 252 the link to a secondary referrer 90, e.g. to email program 99 on one of the secondary referrer's computers.

A secondary referrer 90 may not only distribute the product link 100 to shoppers, but also to further secondary referrers 90. The secondary referrer may use all the same methods to do that as are available to the primary referrer. Arrow 253 shows a secondary referrer copying the product link 100 to a page 94 either from a webpage 84 of the primary referrer or from an email from the primary referrer to web page 94 of the secondary referrer.

Potentially the product link 100 may pass through several, or in principle many more, secondary referrers before it reaches someone who is a shopper, i.e. someone who follows the link to view the product page in the online store. Of course there is nothing to prevent a secondary referrer using the product link as a shopper or a shopper distributing the product link further (and so becoming a secondary referrer). (Note that the distribution of the link 100 via secondary referrers would also be useful if, as in an alternative example, the functions to the referral server were implemented on the online store server.)

Further ways a product page link 100 may be distributed to a shopper, or along the way to a shopper, include mobile phone messages (e.g. SMS, BEM, iMessage), one dimensional bar codes, two dimensional bar codes (e.g. QR codes), posters and leaflets, and even word of mouth or spoken broadcasts. All of these of course contain, e.g. are coded to contain, or actually display in text form, the product link given above.

The referral service server 70 also provides at least some of these in the primary referrer's account pages (a link 310 to which is provided in the pop-up 73B display of the basic text form of the link). Also included in those account pages are graphic buttons containing the link, which the primary referrer may use on websites etc., but which are more attractive to shoppers than text links.

When a shopper 10 has used a product link 100 to visit the online store and then makes a purchase of the product referred to by the product link 100, the primary referrer, who originally generated the product link 100, is credited with a fee or commission. This occurs even if the link was not, when it was followed by the shopper, hosted in the primary referrer's own website. There are two main advantages to this system. First, the primary referrer has considerable flexibility in promoting the product. He is not limited to just using his own website but can have the link seen by his contacts on social media websites and make use of mailing lists. A second advantage is that through the use of secondary referrers the link could end up being distributed very widely and rapidly, especially for a popular or interesting product.

In more detail, once a shopper has clicked 241′ the product link 100 the system proceeds as follows. (See also FIGS. 4E and 404 in FIG. 4A). As explained above the link 100 may have come 240 to the user by being displayed on a website 84, 94 of the primary or a secondary referrer or by an email from the primary or a secondary referrer, or by another method.

The preferred form of the product link 100 described above was a link to the server 70 of the referral service. So when a shopper clicks 241 this link their web browser 11 makes a request 242 to the referral service server 70; that reacts by looking up in its link database 74 the entry having the link ID in the product link 100 supplied in the request from the browser 242. That entry provides the URL of the product page 24 in the online server back to the web browser 11, the referral service server adds the unique link ID from the request 242 to that URL and returns 243 the result to the browser 11 as a redirect command. In response to that the browser 11 follows 244 the new URL and requests 245 the product page 24 from the online store server 20.

For the alternative form of product link 100 mentioned above that contains the URL of the product page explicitly, the shopper's web browser 11 reacts (dashed arrow in FIG. 4E) to the click of that product page link 100 by following 241′ the link directly and requesting 245 the product page 24 from the online store server, which then sends 246 that product page 24.

Either way, the online store server 20 then sends 246 the product page back to the web browser 11 the shopper for display to the shopper. The URL sent to the online store server 20 by the shopper's browser 11 includes the unique link ID mentioned above.

If the alternative form of the link mentioned above is being used (see dotted arrow in FIG. 4E), the online store server 20 then sends 247 a message to the referral service server 70 reporting that the product link has been followed. This is not part of the process for payment of commission to the primary referrer but is to allow the referral service to collect statistics. (The step is not at all needed if the preferred form of the product link was used since the referral service server 70 already knows that the link has been followed because in that case the browser 11 made its initial request 243 to that server when the product link is clicked.)

The online store server 20 records 414 the fact that the shopper came to the product 110-112 via the product link (including noting the link ID) and if the shopper then proceeds to buy the product the online store server 70 proceeds 415 with the shopper's payment as follows.

The online store first makes a request 120 to the payment gateway 40 for the full amount of the goods that was quoted to the shopper during the shopping process, plus of course any shipping costs etc.

The payment gateway 40 effects the payment by making the corresponding payment requests 122 to the bank's server 30, which confirms 123 that that has occurred to the payment gateway 40, which in turn confirms 124 the payment to the online store server 20.

The online store server 20 then sends a message 269 directly to the referral service server 70 noting that a sale has been made using a product link 100 of the referral service, the message including the unique link ID of the particular product link used by the shopper and the count of that product sold. If the transaction included more than one such referred product the message includes the link IDs of the product links 100 used for each of those. Conveniently the code to send the sale report 269 is included as a server side script in a payment confirmation page displayed to the shopper by the online store server once the payment for the goods is confirmed.

For each link ID included in the report, the referral service server 70 reacts by crediting 416 the account, held in its accounts database 75, of the primary referrer of that link with the commission, as calculated in accordance with the commission information for the product provided by the online store earlier. It also debits an account it keeps for the online store with that commission plus an amount on top of that due to the referral service from the online store for providing its service.

Alternatively, for each link ID included in the report, the referral service server 70 reacts by crediting 416 not only the account, held in its accounts database 75, of the primary referrer of that link with the commission, as calculated in accordance with the commission information for the product provided by the online store earlier, but also it credits an account, held in its accounts database 75, for the shopper that bought the product. This account is identified by some identifier for the shopper passed to it by the online store, for example the shopper's email address. If the account does not yet exist it is created and may be accessed by the shopper later. Further, it also debits an account it keeps for the online store with the totals of those commissions plus an amount on top of that due to the referral service from the online store for providing its service.

From time to time, for example daily, the referral service server 70 makes a request 270 to the bank server 30 for payment of the amounts added to the online store's account with it since the last such payment was made. If the payment is successfully made the bank server 30 confirms 231 that to the referral service server 70, which notes the payment in the online store's account with the referral service server.

An alternative example of how the payment of commission is made is as follows. When making the payment request 120′ to the payment gateway server 40 the online store server 30 of course asks the shopper's selected bank account or credit card account, etc., to be debited with the total amount for the goods (and any taxes and delivery costs) but asks for the corresponding credit to be made in two parts: one amount crediting a bank account (etc.) belonging to the referral service with the commission(s) due on the product(s) bought by the shopper as a result of following product link(s), and another amount crediting the bank account (etc.) of the online store, which will be the total price paid by the shopper less the commissions. The payment gateway passes on the request in similar form 122′ to the bank's server 30 and the payment confirmations 123 and 124 are then sent back. Also, the payment gateway 40 (or alternatively the bank server 30 or the online store server 20) sends 272 the referral service server 70 a remittance advice noting both the amounts of commission(s) paid and the unique link ID associated with each commission. The payment gateway is provided with the unique link ID(s) for the purpose by the online store server 20 when the payment is instructed 120′. On receipt of the remittance advice the referral service server 70 credits the commission to the of the primary referrer account that it holds in account database 75, which account it identifies from the unique link ID via the link database 74, with the amount of the commission less an amount for itself. (It may also credit the account of the shopper that it holds, or creates if it does not exist, with part of the commission). In this payment arrangement the online store server has to calculate for itself both the commissions due to the primary referrer(s) and the extra amounts due to the referral service.

The primary referrer can use account administration pages on the referral service server 70 to see the commissions credited to his account there and from time to time request payment of those to a bank account (etc.) of primary referrer. Alternatively the referral service server can make the payments to the bank account (etc.) of the primary referrer automatically periodically or whenever a certain amount of credit has built up. The referral service server 70 requests 273 the banks server 30 to make the payments to the primary referrer, which confirms 274 that the payment is made. If the shopper is also receiving commission at the referral service they are paid that in a similar manner.

The referral payment server 70 not only makes it easy for an online store to provide product links and commissions to primary referrers (and shoppers), the referral payment server can deal with more than one online store at once. This means that a primary referrer can have just a single account with the referral service provider and still be able to promote products from different online stores, without the need to set up individual accounts with each. Also the reports that a primary referrer can obtain from the referral service server integrate information on the commissions paid by all the online stores to which the referrer has linked. By linking to different online stores a primary referrer can be perceived by shoppers as being more independent.

In the above the items available in the online store have been referred to as products. However they may equally be services sold via the online store.

The invention can be extended further, to vouchers used in traditional physical stores as is illustrated by the following example.

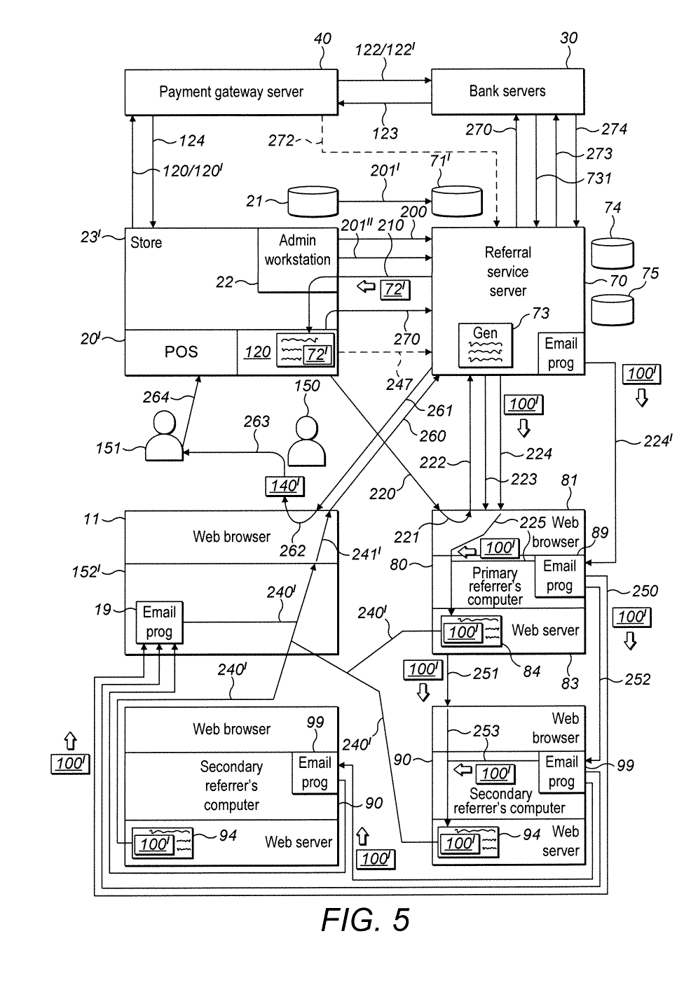

FIG. 5 is a system similar to that of FIG. 2 and has similar items marked with the same reference numerals. In this example however the online store has been replaced by a traditional store 23′, i.e. one that a shopper can visit to buy goods or services.

This system has, instead of the online store server 20′, a point-of-sale (POS) terminal, and this functions differently; the shopper uses a voucher to interact with the point-of sale-terminal, when purchasing the goods. Before that is described in detail, however, the creation and distribution of the voucher explained.

As with the previous example an operator from the store, who may be at the store itself of at some other location, e.g. the administrative headquarters the store, first opens an account at the referral service. They then supply 201″ the details of an item (e.g. goods or services), items, or classes of items, to which the voucher applies, together with details of benefits to be accorded to a shopper when presenting the voucher at the POS terminal (suitably coded for interpretation as such by the store's POS terminal). These details are stored in a voucher database 71′. The benefit may for example be a discount on a particular item or on a class of items, or it may be an entitlement to, or a discount on, additional items, e.g. a “free gift”. These details are also stored in the voucher database 71′ by the referral server. As before, further information can also be provided, for example, the name and cost of the products, and these details can alternatively be obtained by the referral service server 73 from the product database 21 of the store. That database could be part of the physical store's online store, if it has one, or for example, its product database used by its POS system. The data provided by the operator from the store again also includes the commission to be paid to the primary referrer.

The referral service provides 210 to the online store a voucher generation link 72′. This link is an http link to the referral service server 70 and includes a unique identifier identifying the particular voucher. (A store may create more than one voucher relating to different items, or indeed to the same item, for example with different benefits or duration of validity.)

The physical store displays the link somewhere that a primary referrer may come across it, for example, as a hyperlink in a website 120, even an online store 120 it has one, of the physical store. But it could be distributed by various means, including for example a poster in the physical store.

A primary referrer wishing to generate a voucher follows the voucher generation link 72′, e.g. by clicking it 220 in the website 120 of the physical store, or by typing it in to the address bar of their browser 81. The browser follows this link 221 and the referral service server 70 responds and interacts 222, 223, 244 with the primary referrer as in the examples above by logging in the primary referrer to their account but with a voucher link 100′ being the link displayed on page 73B, which link includes a unique ID for the voucher being created. The referral service also generates an image of a voucher and stores it ready to be provided (while it remains in date) as a web page to anyone following the associated voucher link 100′ that has just been displayed to the primary referrer. (While the ID for the voucher is unique it does not stop more than one person printing it out—see below—and using a copy of it).

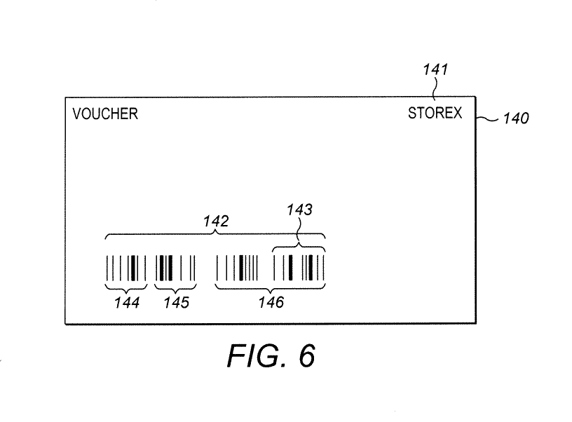

FIG. 6 is a view of the voucher (and also of course is a view of its image); this includes, as well as artwork for example as the logo 141 of store, a scannable element 142, for example a 1-D or a 2-D bar code, which contains information included it by the referral service server for the POS terminal to use. (The information in the scannable element could also for example be presented in alphanumeric characters since these are scannable but this may be less secure against forgery of the voucher and because people being able to easily read the information). The information includes the unique ID 143 for the voucher being created. It can also include data items needed by the POS to process the voucher and award the benefit to the shopper, for example the discount rate 144, the identity 145 of the item, items or class of items to which the voucher applies, and the period of validity of the voucher. Preferably the unique ID for the voucher is part of a link 146 included in the scannable element which points to a provided service in the referral service server that records that the voucher has been used. That service operates in a similar way to that described in the earlier examples above for recording that an online store has made a sale following the use of a product link. Indeed the software maybe arranged to process both the recording of and voucher uses and sales following product link uses.

The voucher link is then distributed by the primary referrer and secondary referrers as in the previous example. At some point a person 150 who has received the link and is interested in having a physical voucher 140′ that can be used at the store 23′ can print it out. That person 150 may be a shopper, but may also be someone who wants to distribute 263 a physical version 140′ of voucher to a shopper 151. The voucher can most usually be printed out on paper or card, but it can also be printed on a 3-D object, a useful example of which would be the packaging of some other goods, e.g a carton or on a beverage can. To obtain a physical version of the voucher that person 150 first uses their browser 11 to follow 241′ the link 100′ to it, and the browser requests 260 the image of the voucher from the referral service server 260, which returns it to the browser 11, from where the person can print it out. They can use the voucher themselves or pass it to a shopper.

Eventually a shopper 151 will obtain either a physical version 140 of the voucher, either from 263 someone else 150 or by printing the voucher image after following the voucher link 100′. The shopper then takes it to the store where they present 264 it at the POS terminal, together with any items needed for it to apply.

The POS terminal 20′ then scans the scannable element 142 to read the information included in it by the referral service server, for example in the bar code. If the unique ID of the voucher therein is in the form of a link 146 it follows that link, which action sends the unique voucher ID to the referral service server 70 which records that a shopper has used the voucher and credits the primary referrer who created the voucher with the commission. (Alternatively the POS 20′ can send the unique ID to the referral service at a predetermined address). The referral service server 70 charges the primary referrer's commission and its service charge to the store 23′ in the same way as in the previous example.

The POS 20′ uses the further data 144, 145 in the scannable element to provide the benefit due with the voucher, for example by applying a discount to the purchase price of an item associated with the voucher. (Alternatively that information is obtained by the POS from the referral service server using the unique voucher ID, the referral service server using that information look up the information).

The primary referrer can obtain payment form the referral service server of 73 of their credited commissions in the same way as in the previous example.

The referral system server may provide vouchers for more than store and monitor their use and provide commission to primary referrers for them.

Again the computers of the system and POS terminal are provided with software to perform the steps described above and so cooperate in the algorithm described to create, distribute, and use the voucher.

The same referral service server 73 can perform both the functions described immediately above for the processing of vouchers and those described earlier above for the processing of product links.

Key to arrows in the FIGS. 1 and 2:
101 Keywords
102 Hit list
103 Select item
104 Item page
105 Add to basket
110 Buy
111 Purchase forms
112 Responses
103′ Follow link to item
104′ Product page
105′ Add to basket
110′ Buy
120/120′ Payment request
122/122′ Payment request
123/123′ Payment confirmation
124 Payment confirmed
130 Sign up
131 Receive link
132 Page request
133 Return page
134 Follow link
245 Select item page
246 Item page
242 Request item page
243 Redirect
251 View page with product link
220 View product page
221 Follow link
222 Request link generation
223 Log in
224 Send product link
200 Open account
201 Product URL
210 Link generation link
269 Report sale
247 Report link clicked
272 Remittance advice
270 Commission payment request
231 Payment confirmation
273 Commission payout request
274 Payment confirmation

What is claimed is:

1. An online store referral system comprising:
an online store server comprising records of items for sale,
a referral service server, separate from the online store server,
a primary referrer, and
a shopper computer system, of a shopper, operative to receive from the primary referrer a link to an item for sale in the online store and to follow that link to make a purchase from the online store of the item for sale,
wherein the online store server is operative to inform the referral service server of a purchase of an item for sale following on from the link for that item being followed, and
wherein the referral service server is operative to credit the primary referrer with a commission in respect of the sale of the item.

2. An online store referral system as claimed in claim 1 wherein the referral service server is also operative to credit the shopper with a commission in respect of the sale of the item.

3. An online store referral system as claimed in claim 1 wherein the online store is operated by a first organisation and the referral service server is operated by a second organisation that is independent of the first organisation.

4. An online store referral system as claimed in claim 1 wherein the referral service server is at a different site from the online store server.

5. An online store referral system as claimed in claim 1 comprising a plurality of online stores, each having an online store server comprising a respective set of records of items for sale,
wherein each online store server of the plurality is operative to inform the referral service server of a purchase of an item for sale following on from the link for that item being followed, and
wherein the referral service server is operative to credit the primary referrer with a commission in respect of each sale of an item so purchased.

6. An online store referral system as claimed in claim 1 wherein the primary referrer has a computer system and wherein the primary referrer computer system and the referral service server are operative to interact to provide the link to the item for sale.

7. An online store referral system as claimed in claim 6 wherein the referral service server is operative to generate the link to the item for sale and to communicate the link to the primary referrer computer system.

8. An online store referral system as claimed in claim 6 wherein the referral system server is operative to record the link to the item for sale.

9. An online store referral system as claimed in claim 1 wherein the referral service server is operative to record the link to the item for sale and wherein the link to the item for sale comprises an identifier from which the referral service system can identify the link.

10. An online store referral system as claimed in claim 1 wherein the referral service server comprises a link generation web page and wherein the online store comprises product web pages each comprising a link to the link generation web page.

11. An online store referral system as claimed in claim 1 wherein the online store server is operative to provide product pages for particular ones of the items it has for sale and wherein the link to an item for sale is a direct link to a product page from the online store server for a particular product.

12. An online store referral system as claimed in claim 1 wherein the online store server is operative to provide product pages for particular ones of items it has for sale, wherein the link to an item for sale is a link to the referral service server, and wherein the referral service server is responsive to the link being followed to cause a redirect to a product page from the online store server for a particular product.

13. An online store referral system as claimed in claim 1 wherein the online store server is operative perform the informing of the purchase of an item by sending a message directly to the referral system server over a communications network.

14. An online store referral system as claimed in claim 1 wherein the online store server, the referral service server, and the shopper computer system are connected by a communications network.

15. A referral service server, wherein the referral service server is
operative to receive, from an online store server separate from the referral service server, information of a purchase of an item for sale by the online store server following on from a link for that item being followed by a shopper that received the link directly or indirectly from a primary referrer, and
operative to credit the primary referrer with a commission in respect of the sale of the item.

16. A referral service server as claimed in claim 15 wherein the referral service is also operative to credit the shopper with a commission in respect of the sale of the item.

17. A referral service server as claimed in claim 15 wherein the referral service server is operated by a second organisation that is independent of a first organisation that operates the online store.

18. A referral service server as claimed in claim 15 wherein the referral service server is at a different site from the online store server.

19. A referral service server as claimed in claim 15
wherein the referral service server is operative to credit the primary referrer with a commission in respect of each sale of an item purchased following on from the link for that item being followed, at a plurality of online stores.

20. A referral service server as claimed in claim 15 wherein the referral service server is operative to interact with a computer system of the primary referrer to provide the link to the item for sale.

21. A referral service server as claimed in claim 20 wherein the referral service server is operative to generate the link to the item for sale and to communicate the link to the primary referrer computer system.

22. A referral service server as claimed in claim 20 wherein the referral system server is operative to record the link to the item for sale.

23. A referral service server as claimed in claim 15 wherein the referral service server is operative to record the link to the item for sale and wherein the link to the item for sale comprises an identifier from which the referral service system can identify the link.

24. A referral service server as claimed in claim 15 wherein the referral service server comprises a link generation web page.

25. A referral service server as claimed in claim 15 wherein the referral service server is operative to generate the link to an item for sale in the online store in form that is a direct link to a product page the online store server for a particular product.

26. A referral service server as claimed in claim 15 wherein the referral service server is operative to generate the link to an item for sale in the online store in form that is a link to the referral service server, and wherein the referral service server is responsive to the link being followed to cause a redirect to a product page from the online store server for a particular product.

27. A method of selling an item online comprising:
generating a link to a product for sale in an online store associated with a primary referrer,
distributing the link to the product to a shopper,
the shopper following the link and purchasing the product from the online store,
the online store informing a referral service, separate from the online store, of the purchase, and
the referral service crediting the primary referrer with a commission for the sale of the item.

28. A method as claimed in claim 27 further comprising the referral service crediting the shopper with a commission for the sale of the item.

29. A method as claimed in claim 27 wherein the online store is operated by a first organisation and the referral service is operated by a second organisation that is independent of the first organisation.

30. A method as claimed in claim 27 wherein the referral service is at a different site from the online store.

31. A method as claimed in claim 27 wherein a plurality of online stores inform the referral service of purchases following a shopper following the link, and the referral service credits the primary referrer with a commission for those sales of items.

32. A method as claimed in claim 27 wherein the link comprises an identifier from which the referral service can identify the link.

33. A method as claimed in claim 27 wherein the link is a direct link to a product page from the online store for a particular product.

34. A method as claimed in claim 27 wherein the link is to a server of the referral service, the method including the referral service server being responsive to the link being followed to cause a redirect to a product page from the online store for a particular product.
